(19) United States
(12) Patent Application Publication
(10) Pub. No.: US 2005/0092663 A1
(43) Pub. Date: May 5, 2005

(54) Safety equipment applicable to water purifiers

(76) Inventor: Jose Soriano Sansano, Elche (Alicante) (ES)

Correspondence Address: KLAUBER & JACKSON, 4th Floor, 411 Hackensack Avenue, Hackensack, NJ, 07601, US

(21) Appl. No.: 10/961,386

(22) Filed: Oct. 7, 2004

Related U.S. Application Data
(63) Continuation of application No. PCT/ES03/00154, filed on Apr. 4, 2003.

(30) Foreign Application Priority Data
Apr. 8, 2002 (ES) U200200875

(51) Int. Cl. B01D 35/14

(52) U.S. Cl. 210/97; 210/234; 210/248

(57) ABSTRACT

It is equipment that passively interrupts the supply of water to the purifier when there is a water leak in order to prevent risks of flooding. The equipment basically comprises some passive means that will actuate a supply valve (3) closing the same, in such a way that the liquid that is leaking has the purpose of breaking a breakable part (7) when coming in contact with the liquid that has leaked, thus interrupting the supply of the purifier.

### RELATED APPLICATIONS

The present application is a Continuation of co-pending PCT Application No. PCT/ES03/00154, filed Apr. 4, 2003, which in turn, claims priority from Spanish Application Serial No. 200200875, filed Apr. 8, 2002. Applicants claim the benefits of 35 U.S.C. §120 as to the PCT application and priority under 35 U.S.C. §119 as to said Spanish application, and the entire disclosures of both applications are incorporated herein by reference in their entireties.

### OBJECT OF THE INVENTION

The invention consists of safety equipment applicable to water purifiers that seeks to avoid possible leaks in dwellings and premises, as a result of the leaks produced in water purifiers, either by the existence of pores, or by the connections.

Hence, it is equipment that has the purpose of passively interrupting the supply of water to the purifier when there is a water leak for the purpose of preventing risks of flooding.

### BACKGROUND OF THE INVENTION

Water purifiers include among their parts a supply valve, as well as an assembly of couplings and joints, which although they include different sealing means, such as for example, joints and other parts, after a certain amount of time leaks are sometimes produced. These leaks can cause dwellings and premises to be flooded and at the very best, moisture and leaks that would require repair afterwards are produced.

### DESCRIPTION OF THE INVENTION

In order to achieve the aims of the invention and to avoid the above-cited inconveniences, the invention proposes safety equipment applicable to water purifiers wherein said equipment comprises passive means that have the purpose of interrupting the supply of water to the purifier when a water leak has been caused.

For this purpose, the equipment is complemented with a receptacle which in principle has the purpose of collecting the water resulting from the possible water leak, in such a way that when the level of water in the receptacle reaches the piece of cardboard or the like, the latter breaks and then the supply valve is closed by the action of an antagonistic spring or any other means tending to close said valve, such as a counterweight for example.

The part that is breakable when it comes in contact with the liquid may be made of cardboard or any other material that is breakable when it actually comes in contact with that liquid.

The breakable part when it comes in contact with water could easily be placed in an area as close to the bottom of the receptacle as desired for the purpose of interrupting the supply to the purifier as soon as possible.

Another possibility would be a second small bottom recess in the bottom of the receptacle so that the interruption of the supply to the purifier is even faster if possible.

The receptacle, aside from acting as a vessel itself to accumulate water so that the water may reach the breakable part, will also prevent from the first drop of water spilt that no leaks or moisture are produced.

The purifier assembly will be housed inside the receptacle or at least arranged therein vertically for the purpose that any water leak reaches the inside of the receptacle without said water spilling outside the receptacle.

Hereinafter to provide a better understanding of this specification and forming an integral part thereof, some figures wherein the object of the invention has been represented in an illustrative and non-restrictive manner are attached hereto.

### BRIEF DESCRIPTION OF THE DRAWINGS

FIG. 1 shows a perspective view of the safety equipment applicable to water purifiers, object of the invention.

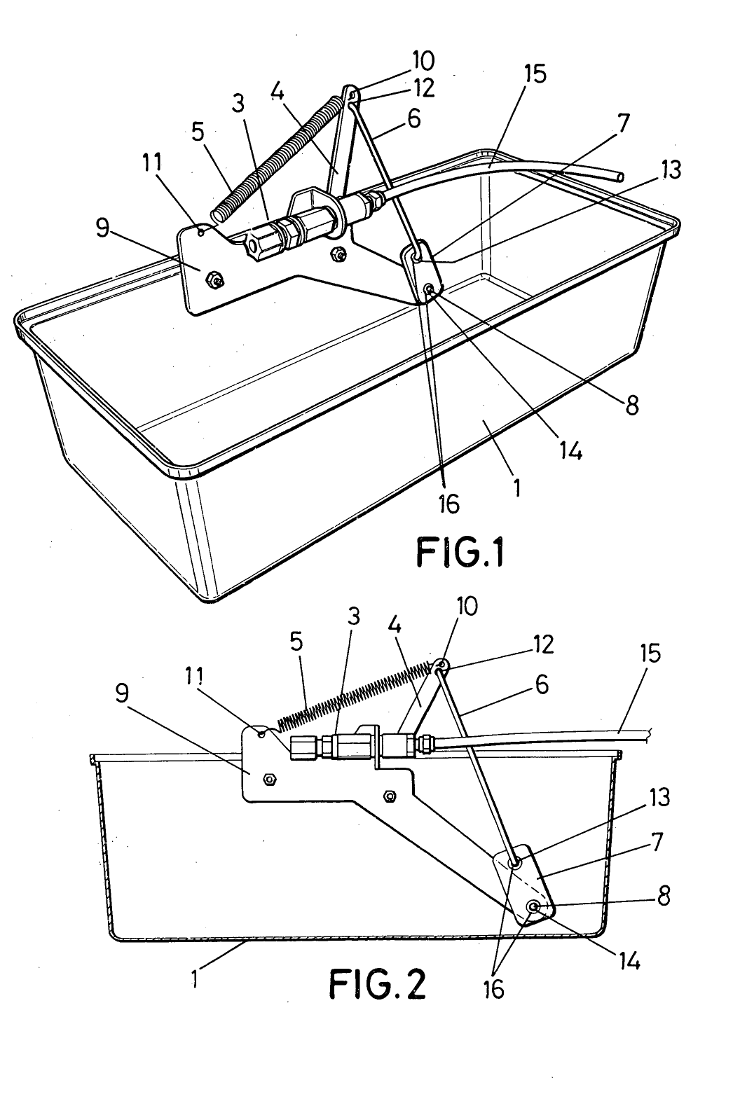

FIGS. 2 and 3 show some raised views of the device of the invention.

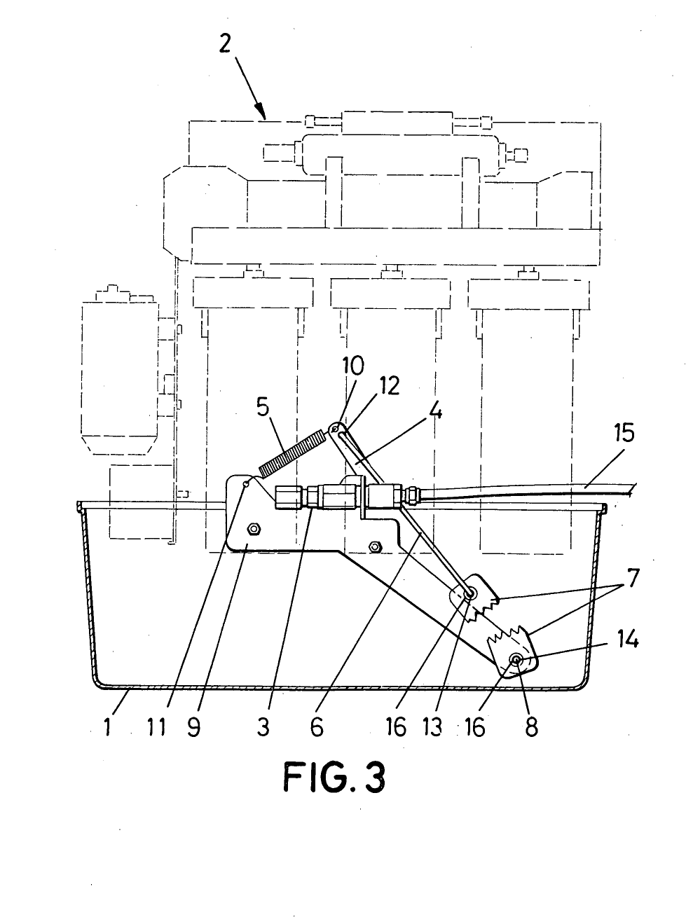

### DESCRIPTION OF THE PREFERRED EMBODIMENT

An example of the embodiment is described hereinafter using the numbering used in the figures.

It is defined from a receptacle (1) wherein at least partially the assembly of a purifier (2) is housed, in such a way that any leak that is produced will be collected by this receptacle (1).

There is a supply valve (3) of the purifier (2) that can be opened and closed by means of a outside control defined by a lever (4), which is connected to a spring (5) tending to keep said valve (3) closed, although said valve (3) will normally be open thanks to a tie rod (6) hooked also to the control lever (4), a tie rod (6), connected in turn with a piece of cardboard (7) anchored in the front stub (8) located, just like the piece of cardboard (7) in a bottom area of the receptacle (1), in such a way that when there are water leaks, the liquid drops inside the receptacle (1) until the level of water therein reaches the piece of cardboard (7), which when coming in contact with water breaks. Obviously the tension of the antagonistic spring (5) helps in doing so.

When this happens, the spring (5) tending to close the supply valve (3), the supply of liquid is automatically and passively cut off, thus avoiding any undesired flooding, leaks or moisture.

The supply valve (3), as well as the purifier assembly are connected to the receptacle (1) by means of a support (9) anchored to a side wall of said receptacle (1), in such a way that the spring (5) is hooked by one end in a hole (10) of the control lever (4) of the supply valve (3), whereas the other end is anchored in another hole (11) made in a top area of the support (9).

The control lever (4) of the supply valve (6) includes a second hole (12) where an end of the tie rod (6) hooks, whereas the other end hooks in a top hole (13) of the piece of cardboard (7), which in turn has another bottom hole (14), through which the cited piece of cardboard (7) is anchored in the front stub (8) integral to the support (9) fastened to the receptacle (1).

The supply of liquid to the supply valve (3) and therefore to the purifier assembly obviously arrives through a tube (15).

On the other hand, the holes (13) and (14) of the piece of cardboard (7) are reinforced by means of some ring-shaped rivets (16 in order to prevent inappropriate ripping or breakage of said piece of cardboard (7).

1. Safety equipment applicable to water purifiers, that being used to avoid moisture and small or big flooding when water leaks are produced in the purifier assembly, which includes a supply valve wherein it includes passive means that actuate the supply valve closing the same when there are water leaks, in such a way that the liquid that is leaking has the purpose of wetting a breakable part when it comes in contact with the liquid that has leaked, a part that normally keeps the supply valve open against the resistance of an antagonistic part tending to close the supply valve.

2. Safety equipment applicable to water purifiers, according to claim 1, wherein the breakable part (7) when coming in contact with the water is anchored at one end to a fixed point, whereas at the other end, it is connected to a control lever of the supply valve by means of an intermediate tie rod; the antagonistic part tending to close the supply valve by means of the control lever being connected to said control lever.

3. Safety equipment applicable to water purifiers, according to claim 1, wherein the antagonistic element consists of a spring.

4. Safety equipment applicable to water purifiers, according to claim 1, wherein the antagonistic part consists of a counterweight.

5. Safety equipment applicable to water purifiers, according to claim 1, wherein it includes a receptacle where the purifier assembly is housed and that said receptacle is used as a tank for collecting the water that has leaked, there also being in the receptacle the breakable part that comes in contact with the liquid, in such a way that when the level of water that has leaked that drops inside the receptacle reaches the cited part, said part breaks and then the supply valve is put in a closed position by the action of the antagonistic part tending to close said supply valve.

6. Safety equipment applicable to water purifiers, according to claim 5, wherein it includes a support integral to the receptacle and on which the purifier is fastened, as well as the supply valve, the antagonistic part also connecting at its free end to said support, as well as the fixed connecting point of the breakable part that comprises said fixed point by a front stub where said breakable part is jointed.

7. Safety equipment applicable to water purifiers, according to claim 1, wherein the breakable part is essentially made of cardboard or a similar material.

8. Safety equipment applicable to water purifiers, according to claim 2, wherein the end connecting points of the breakable part when coming in contact with water are jointed thanks to some front holes reinforced by some ring-shaped rivets that surround said holes made in the breakable piece.
